(19) United States
(12) Patent Application Publication
(10) Pub. No.: US 2019/0325852 A1
(43) Pub. Date: Oct. 24, 2019

(54) CONTROLLABLE GUITAR PICK

(71) Applicant: Gary Richard, Danvers, MA (US)

(72) Inventor: Gary Richard, Danvers, MA (US)

(21) Appl. No.: 16/389,985

(22) Filed: Apr. 21, 2019

Related U.S. Application Data
(60) Provisional application No. 62/660,263, filed on Apr. 20, 2018.

(51) Int. Cl. G10D 3/16

(52) U.S. Cl. CPC G10D 3/163

(57) ABSTRACT

The present invention is a guitar pick for being able to control the orientation and retention of the instrument pick. A controllable guitar pick having an open field that allows finger to finger contact for controllability and a pathway for sweat to exit having a left stable field and right stable field, the left stable field and right stable field are identical fields symmetrical about a Y axis, a wide stability field on a top of the open field and a bottom field opposite the wide stability field opposite about an X axis

### CONTROLLABLE GUITAR PICK

This application claims priority to U.S. provisional application 62/660,263 filed on 20 Apr. 2018, the entire disclosure of which is incorporated by reference.

### BACKGROUND OF THE INVENTION

### Field of the Invention

The present invention is in the field of guitar accessories. More specifically, the present invention is a controllable guitar pick.

### Background of the Invention

The present invention is a guitar pick for being able to control the orientation and retention of the instrument pick

The present invention provides important gripping which helps to prevent picks from being dropped, and also improves position stability.
The present invention is in making the guitar pick easier to maintain gripping orientation on each axis, therefore gaining greater stability, and more consistent alignment when playing the guitar strings. Most guitar picks are small, thin, and typically smooth, which makes them prone to unwanted movement, inconsistent orientation, misalignment, and instability.

Another benefit of the present invention is for the improved retentive gripping, minimizing picks being dropped during performance. Dropping picks during performing/playing, is a reality of life, when playing a guitar. As previously mentioned, guitar picks are small, thin, and typically smooth which makes them prone to slipping out of the player's fingers, which is very disruptive to the performance. There have been many textured guitar picks designed, with enhanced gripping surfaces, to mitigate the slippage factor. The present invention greatly reduces the risk of the pick being dropped.

Another benefit of the present invention, is tethering. The pick can be tethered to lanyards, or other devices, which gives the guitarist many other options for transport, and accessibility.

Another benefit of the present invention also allows other add-ons, and attachments, such as grommets, elastics or novelties which can aid in the performance and enhance the previously listed benefits.

Another benefit of the present invention is in creating greater flexure, if desired. By rotating the pick or by changing the finger position or by changing the strength of the grip the present invention creates another dynamic which may be desirable when

The guitar pick, as we know it today, or plectrum as it is called in the UK, was made from tortoise shell in the 19th century. Prior to that feather quills were the most common material for picking guitars and related instruments. The industry states that combined manufacturers produce hundreds of millions of picks every year, but the majority are produced by three major manufacturers, Dunlop, Fender, and Clayton. The average customized production for touring bands, would be 7,000, as many are thrown out to the fan during performances. Pick collecting is very popular, there are web sites and publications dedicated to the subject.

The Four Pick Characteristics. Players will often switch styles of picks, depending on the style of music. Shape: The overall shape has less effect on tone, it has more to do with comfort, and handling. The vast majority of picks fall into the standard teardrop shapes. That being said, the tip, or point does have a clear effect on the playability, and tone. Many believe that that for fast playing, a highly pointed pick is the best shape for speed, but they tend to wear down more quickly.

Thickness: Affects tone, and dictates how much give the pick has as it pulls across the string during the attack. Certain styles of playing are even rooted in a certain thickness of pick. Lighter picks provide a brighter tone, but flex more, and break more easily, they tend to be used more for strumming. Single note runs will not have the same power or resonance on acoustic guitars, but can be effective on electric guitars. Medium picks, the most common used, produce a more even tone, and have good durability and good sound quality. These are the general choice for soft rock and country music. Heavier picks provide a deeper, more aggressive tone, they are more durable, and are the thickness preferred by Jazz players who use heavy gauge strings. Because these are thicker, harder, and less flexible, they are more difficult to grasp, keep in control, they tend to slip more. Extra Light (less than 0.44 mm) Light (approx. 0.44 to 0.69 mm) Medium (approx. 0.70 to 0.84 mm) Heavy (approx. 0.85 to 1.50 mm)

Extra Heavy (greater than 1.50 mm)

Materials: Plastic, metal, bone, horn, stone, wood, even refashioned coins. Current materials are mostly celluloid, Delrin, Nylon, Tortex, or Acetal. Material tends to less effect on electric guitars, but does more so on acoustic guitars, as the interplay of contact of the string and pick is more magnified. Harder materials tend to have a brighter attack. Nylon and softer materials have a slower attack.

Texture: Picks generally are thin and smooth, making them slippery, especially when sweating. Some picks provide a textured surface, or a high friction coating to aid

The second biggest issue with guitar picks, is pick management. The first challenge is the ability to keep them stabilized for playing orientation to the strings, as they will tend to rotate when contact is made. Secondly, is the ability to retain them, and not drop them during play. Guitar picks are small, thin, and typically are made from smooth plastic, sweat makes these challenges worse.

The present invention maximizes X and Y axis stability, in a virtual 1:1 ratio, a stabilization slot in the pick with 2 symmetrical stabilization fields about the Y axis, and one central stabilization field with a top and bottom field in the center of the pick. The overall length and width of the stabilization slot has been maximized, without weakening the overall structural strength of the pick. The invention, removes the pick material in the design in order for the player's fingers to make contact with each other, and to also provide a space for sweat to channel away from the flat surface.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a controllable guitar pick, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

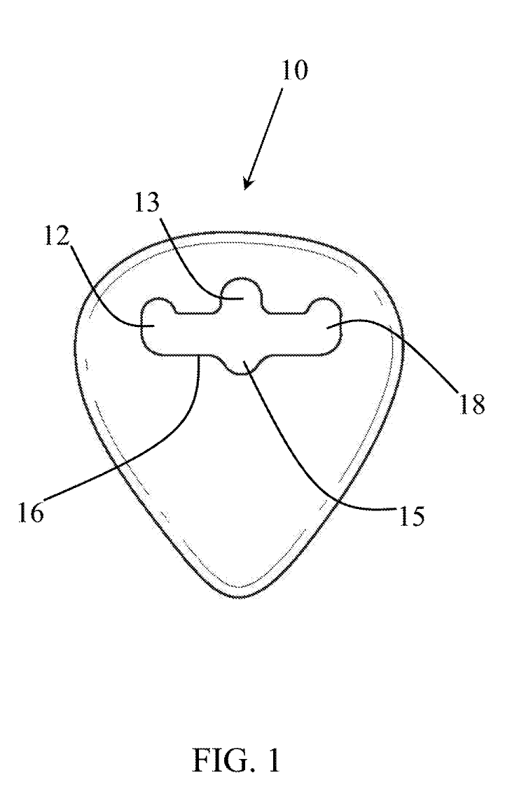

Referring now to FIG. 1, illustrated is a controllable guitar pick, in accordance with one embodiment of the present invention. In FIG. 1, illustrated is a controllable guitar pick 10 shown are two stable identical fields symmetrical about a Y axis the two stable identical fields symmetrical about a Y axis are left stable field 12 and right stable field 18. Shown is an open field 16 for finger to finger contact and wide stability field 13 on the top of open field 16 and a bottom field 15 opposite the wide stability field 13 about an X axis.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A controllable guitar pick comprising:
an open field that allows finger to finger contact for controllability and a pathway for sweat to exit having a left stable field and right stable field, the left stable field and right stable field are identical fields symmetrical about a Y axis, a wide stability field on a top of the open field and a bottom field opposite the wide stability field opposite about an X axis

2. The controllable guitar pick according to claim 1, wherein overall length and width of the open field is maximized without weakening an overall structural strength of the pick.

3. The controllable guitar pick according to claim 1, wherein the open field of the pick maximizes X axis and Y axis stability in a 1:1 ratio X to Y axis.

4. The controllable guitar pick according to claim 1, wherein the open field allows finger to finger contact for controllability by sending tactile feedback to a user.

5. The controllable guitar pick according to claim 4, wherein the user is a guitar player.

6. The controllable guitar pick according to claim 1, wherein the open field allows finger to finger contact for controllability by sending tactile feedback to a guitar player the tactile feedback prevents the guitar player from dropping the pick.

7. The controllable guitar pick according to claim 1, wherein the open field of the pick maximizes X axis and Y axis stability in a 1:1 ratio X to Y axis to maintain gripping orientation on each axis therefore gaining greater stability and more consistent alignment when playing guitar strings.

8. A pick comprising:
an open field that allows finger to finger contact for controllability by sending tactile feedback to a user.

9. The pick according to claim 8, wherein the tactile feedback prevents the user from dropping the pick.

10. The pick according to claim 8, wherein the open field is a pathway for sweat to exit the pick.

11. The pick according to claim 8, wherein the open field maintains gripping orientation on each axis of the pick which gains greater stability and more consistent alignment when the user plays guitar strings.

12. A pick comprising:
an open field that allows finger to finger contact for controllability by sending tactile feedback to a user, the tactile feedback prevents the user from dropping the pick, the open field is a pathway for sweat to exit the pick, the open field maintains gripping orientation on each axis of the pick which gains greater stability and more consistent alignment when a user plays guitar strings
